(19) United States
(12) Patent Application Publication
(10) Pub. No.: US 2026/0066739 A1
(43) Pub. Date: Mar. 5, 2026

(54) MOTOR COOLING STRUCTURE FOR A VEHICLE

(71) Applicants: HYUNDAI MOTOR COMPANY, Seoul (KR); KIA CORPORATION, Seoul (KR)

(72) Inventors: Won Seok Lee, Suwon-si (KR); Sun Sung Kwon, Anyang-si (KR); Baek Yu Kim, Hwaseong-si (KR); Chul Min Ahn, Ansan-si (KR); Jun Young Ha, Gwacheon-si (KR); Su Hyeon Maeng, Seoul (KR); Dong Hui Cheon, Seoul (KR); Yun Kyung Ji, Seoul (KR); Tal Chol Kim, Bucheon-si (KR); Sung Gon Byun, Hwaseong-si (KR)

(73) Assignees: HYUNDAI MOTOR COMPANY, Seoul (KR); KIA CORPORATION, Seoul (KR)

(21) Appl. No.: 18/823,286

(22) Filed: Sep. 3, 2024

(51) Int. Cl. H02K 5/20; B60K 1/00

(52) U.S. Cl. CPC H02K 5/207; B60K 2001/006

(57) ABSTRACT

A motor cooling structure for a vehicle includes: an inflow duct configured to guide traveling wind of the vehicle to a motor, and a first air room and a second air room formed to direct air supplied from the inflow duct to flow around coils on both sides of a stator core, respectively. The motor cooling structure further includes a discharge duct configured to discharge air passing through the first air room and the second air room to the outside.

### BACKGROUND

### Field

The present disclosure relates to cooling of a motor mounted in a vehicle.

### Description of the Related Art

A motor installed to provide the driving power to vehicles generates a lot of heat, and thus proper cooling is essential.

Conventionally, the motor for a vehicle is cooled by forcibly circulating oil, coolant, etc. or cooled by providing cooling fins that may exchange heat with air.

When the oil or coolant forcibly circulates, additional pumps, piping components, etc. are required, resulting in problems of increasing a weight of the vehicle and increasing volumes of motor-related components. When the cooling fins are cooled with air, there is a problem that cooling efficiency is degraded because cooling is performed indirectly through the cooling fins.

The matters described as the background art of the disclosure are for the purpose of enhancing the understanding of the background of the present disclosure and should not be taken as acknowledging that they correspond to the related art already known to those having ordinary skill in the art.

### SUMMARY

The present disclosure is directed to providing a motor cooling structure for a vehicle, which can secure the durability of a motor at a relatively low cost and enable a stable operation by enabling the efficient cooling of the motor with a relatively simple configuration, and ultimately increase the energy efficiency of the vehicle by reducing a weight of the vehicle.

According to an embodiment of the present disclosure, a motor cooling structure for a vehicle may include: an inflow duct configured to guide traveling wind of the vehicle to a motor; a first air room and a second air room formed to direct air supplied from the inflow duct to flow around coils on both sides of a stator core, respectively. The motor cooling structure may further include a discharge duct configured to discharge air having passed through the first air room and the second air room to the outside.

In one embodiment, the first air room and the second air room may be formed in donut shapes of different sizes, and a connection passage connecting the first air room to the second air room may be formed in the stator core.

In one embodiment, the inflow duct and the discharge duct may be connected to opposite sides with respect to donut-shaped centers of the first air room and the second air room.

In an embodiment, the inflow duct may include an inflow duct body having one air inlet, a first inflow branch duct branched from the inflow duct to be connected to the first air room, and a second inflow branch duct branched from the inflow duct body to be connected to the second air room.

In an embodiment, the motor cooling structure may further include: an additional air room formed to surround the stator core so that air flows therein between the first air room and the second air room, and an additional inflow branch duct branched to supply air from the inflow duct body to the additional air room.

In an embodiment, the first air room may include a first air room inner plate having a plurality of coil insertion holes through which portions of the coils pass and installed at one side of the stator core. The first air room may further include a first air room outer plate coupled to the first air room inner plate and having a first inflow hole communicating with the first inflow branch duct and a first discharge hole communicating with the discharge duct formed therein. In another embodiment, the second air room may include a second air room inner plate having a plurality of coil insertion holes through which portions of the coils pass and installed at one side of the stator core. The second air room may further include a second air room outer plate coupled to the second air room inner plate and having a second inflow hole communicating with the second inflow branch duct and a second discharge hole communicating with the discharge duct formed therein.

In an embodiment, the motor cooling structure may further include a motor housing. The motor housing includes a first inflow port, a second inflow port, a first discharge port, and a second discharge duct that are respectively connected to the first inflow branch duct, the second inflow branch duct, and the discharge ducts. The motor housing may be provided outside the stator core, the first air room inner plate, the first air room outer, the second air room inner plate, and the second air room outer plate.

The motor housing may be provided with a partition wall configured to divide the motor housing into a first space where the stator core, the first air room inner plate, the first air room outer, the second air room inner plate, and the second air room outer plate are accommodated, and a second space where a rotational shaft transmits power to other components.

The inflow duct may be provided with an air selection valve configured to selectively supply cooling air blown from a blower of a vehicle air conditioner to the motor.

In addition, to achieve the object, a motor for a vehicle according to the present disclosure includes a stator core, and a first air room and a second air room formed to selectively receive traveling wind of the vehicle or air blown from a blower of a vehicle air conditioner to flow the air around coils on both sides of the stator core, respectively.

The first air room and the second air room may be formed in donut shapes of different sizes, and a connection passage connecting the first air room to the second air room may be formed in the stator core.

The motor may further include an additional air room formed to surround the stator core so that air flows therein between the first air room and the second air room to selectively receive the traveling wind of the vehicle or the air blown from the blower of the vehicle air conditioner.

The first air room may include: a first air room inner plate having a plurality of coil insertion holes through which portions of the coils pass and installed at one side of the stator core, and a first air room outer plate coupled to the first air room inner plate and having a first inflow hole into which air flows and a first discharge hole through which the air is discharged. The second air room may include a second air room inner plate having a plurality of coil insertion holes through which portions of the coils pass and installed at one side of the stator core, and a second air room outer plate coupled to the second air room inner plate and having a second inflow hole into which air flows and a second discharge hole through which the air is discharged.

In another embodiment, a motor housing is provided. The motor housing includes a first inflow port and a second inflow port into which air flows, and a first discharge port and a second discharge duct through which the air is discharged. The motor housing may be provided outside the stator core, the first air room inner plate, the first air room outer, the second air room inner plate, and the second air room outer plate.

The motor housing may be provided with a partition wall configured to partition the motor housing into i) a space in which the stator core, the first air room inner plate, the first air room outer, the second air room inner plate, and the second air room outer plate are accommodated, and ii) a space in which a rotational shaft transmits power to other components.

According to the present disclosure, it is possible to secure the durability of a motor at a relatively low cost and enable a stable operation by enabling the efficient cooling of the motor with a relatively simple configuration, and ultimately increase the energy efficiency of the vehicle by reducing a weight of the vehicle.

### BRIEF DESCRIPTION OF THE DRAWINGS

FIG. 1 is a view showing a motor cooling structure for a vehicle according to an embodiment of the present disclosure.

FIG. 2 is a view illustrating main parts of the motor cooling structure of FIG. 1.

FIG. 3 is a cross-sectional view along line III-III in FIG. 1.

FIG. 4 is a cross-sectional view along line IV-IV in FIG. 2.

FIG. 5 is an exploded view of a configuration of the main parts of the motor cooling structure in FIG. 2.

FIG. 6 is a view illustrating a stator core, a first air room, and a second air room of the motor cooling structure in an embodiment of the present disclosure.

FIG. 7 is a view in a VII direction of FIG. 6.

FIG. 8 is a view in a VIII direction of FIG. 6.

FIG. 9 is a view showing an embodiment in which an additional air room is further provided.

FIGS. 10 to 12 are views illustrating various embodiments of an inflow duct and a discharge duct.

FIG. 13 is a view describing an embodiment in which an air selection valve is added.

FIG. 14 is a table showing various cooling states of a motor that may be implemented when the air selection valve is added.

FIGS. 15 and 16 show modified examples of FIGS. 1 and 3 respectively.

### DETAILED DESCRIPTION

Hereinafter, embodiments disclosed in the present disclosure are described in detail with reference to the accompanying drawings, and the same or similar components are denoted by the same reference numerals regardless of the drawing symbols, and overlapping descriptions thereof will be omitted.

The suffixes “module” and “unit” for components used in the following description are given or used interchangeably in consideration of ease of preparing the specification and not have meanings or roles that are distinct from each other by themselves.

In describing the embodiments disclosed in the present disclosure, when it is determined that a detailed description of a related known technology may obscure the gist of the embodiments disclosed in the present disclosure, a detailed description thereof has been omitted. In addition, the accompanying drawings are only for easy understanding of the embodiments disclosed in the present disclosure, and it should be understood that the technical spirit disclosed in the present disclosure is not limited by the accompanying drawings, and all changes, equivalents, or substitutes included in the spirit and technical scope of the present disclosure are included in the accompanying drawings.

Terms including ordinal numbers such as first or second may be used to describe various components, but the components are not limited by the terms. The terms are used only for the purpose of distinguishing one component from another.

When a certain component is described as being “connected” or “coupled” to another component, it should be understood that the certain component may be directly connected or coupled to another component or other components may be present therebetween. On the other hand, when a certain component is described as being “directly connected” or “directly coupled” to another component, it should be understood that other components are not present therebetween.

The singular includes the plural unless the context clearly dictates otherwise. When a component, device, element, or the like of the present disclosure is described as having a purpose or performing an operation, function, or the like, the component, device, or element should be considered herein as being “configured to” meet that purpose or to perform that operation or function.

In the present disclosure, it should be understood that the term “comprise” or “have” is intended to specify that a feature, a number, a step, an operation, a component, a part, or a combination thereof described in the present disclosure is present, but do not preclude the possibility of the presence or addition of one or more other features, numbers, steps, operations, components, parts, or combinations thereof.

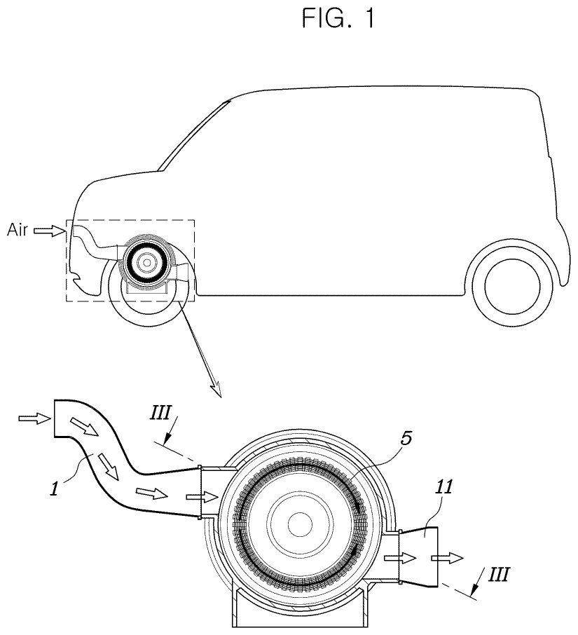

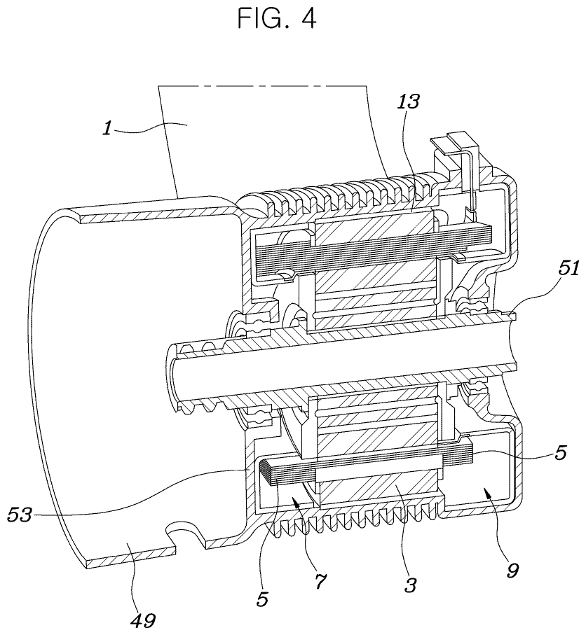

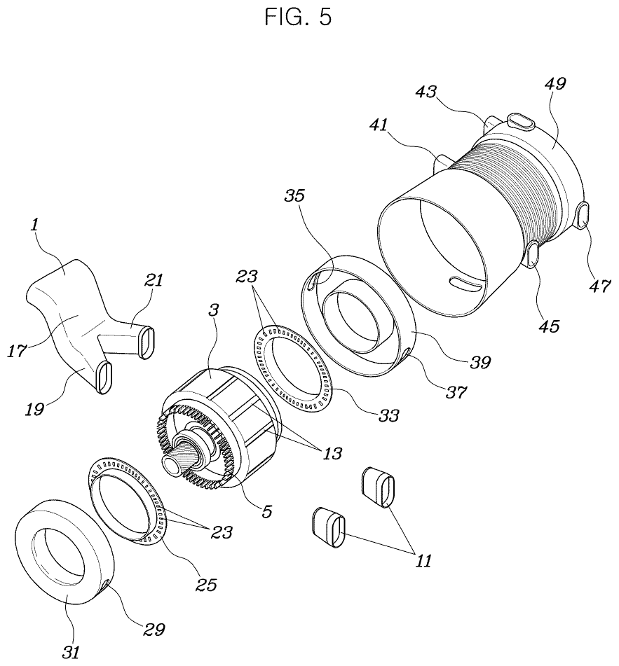

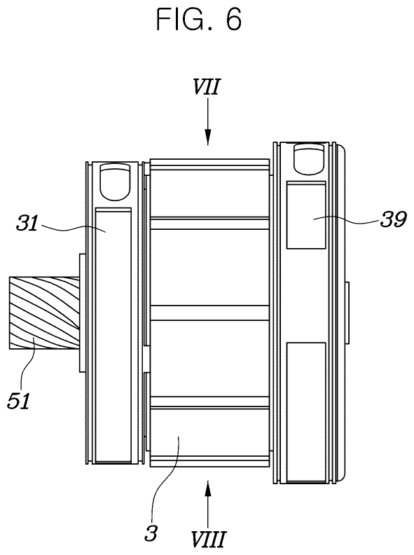

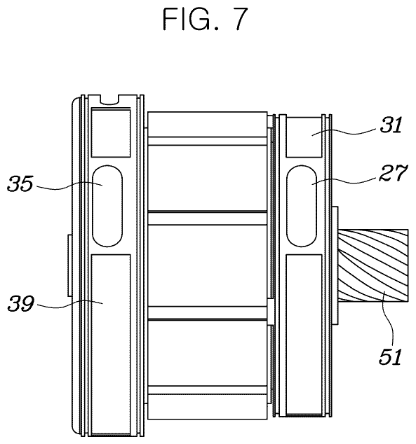

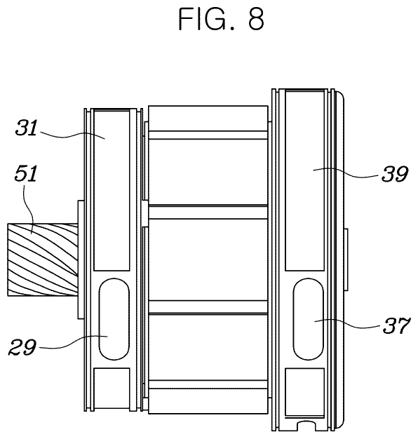

Referring to FIGS. 1 to 8, a motor cooling structure for a vehicle according to an embodiment of the present disclosure includes: an inflow duct 1 for guiding the traveling wind of the vehicle to a motor, and a first air room 7 and a second air room 9 that are formed to direct the air supplied from the inflow duct 1 to flow around each of coils 5 on both sides of a stator core 3. The motor cooling structure further includes a discharge duct 11 provided to discharge air that has passed through the first air room 7 and the second air room 9 to the outside.

In other words, the motor cooling structure may guide the traveling wind of the vehicle to the inflow duct 1 to flow the traveling wind to the first air room 7 and the second air room 9 on both sides of the stator core 3 of the motor so that the air directly cools the coils 5 of the motor, and thus the air may come into direct contact with the heated coils 5 without the use of a separate pump, etc. to cool the coils, thereby achieving high cooling efficiency.

In one embodiment, the first air room 7 and the second air room 9 are formed in donut shapes of different sizes, and a connection passage 13 connecting the first air room 7 to the second air room 9 is formed in the stator core 3.

Therefore, a flow rate of air passing through the first air room 7 differs from a flow rate of air passing through the second air room 9. Due to a pressure difference caused by the difference in flow rate, the air in the first air room 7 or the second air room 9 flows to the second air room 9 or the first air room 7 through the connection passage 13 to cool the stator core 3. For example, the air in the first air room 7 may flow to the second air room 9 through the connection passage 13 to cool the stator core 3. The air in the second air room 9 may flow to the first air room 7 through the connection passage 13 to cool the stator core 3.

Therefore, the stator core 3 and the coils 5 that are most heated may be effectively cooled by air, thereby maintaining a smooth and stable operation of the motor and prevent or avoid the degradation of durability.

The inflow duct 1 and the discharge duct 11 are connected to opposite sides with respect to the donut-shaped centers of the first air room 7 and the second air room 9.

Therefore, air supplied to the first air room 7 and the second air room 9 through the inflow duct 1 is divided into both semicircles of the donut shape, flows, then re-joins, and discharged through the discharge duct 11.

The inflow duct 1 may include: an inflow duct body 17 having one air inlet 15, a first inflow branch duct 19 branched from the inflow duct body 17 to be connected to the first air room 7, and a second inflow branch duct 21 branched from the inflow duct body 17 to be connected to the second air room 9.

With this arrangement, air flowing into the air inlet 15 of the inflow duct body 17 is configured to be divided between the first inflow branch duct 19 and the second inflow branch duct 21 to flow into the first air room 7 and the second air room 9, respectively.

In one embodiment, the first air room 7 may include: a first air room inner plate 25 having a plurality of coil insertion holes 23 through which portions of the coils 5 may pass and installed at one side of the stator core 3, and a first air room outer plate 31 coupled to the first air room inner plate 25 and having a first inflow hole 27 communicating with the first inflow branch duct 19 and a first discharge hole 29 communicating with the discharge duct 11 formed therein.

In other words, the first air room inner plate 25 and the first air room outer plate 31 are coupled to form the donut-shaped first air room 7, and the first inflow hole 27 and the first discharge hole 29 are formed in the first air room outer plate 31 to allow air to flow into and be discharged from the first air room 7.

In addition, the second air room 9 may include: a second air room inner plate 33 having a plurality of coil insertion holes 23 through which portions of the coils 5 may pass and installed at one side of the stator core 3, and a second air room outer plate 39 coupled to the second air room inner plate 33 and having a second inflow hole 35 communicating with the second inflow branch duct 21 and a second discharge hole 37 communicating with the discharge duct 11 formed therein.

In other words, the second air room inner plate 33 and the second air room outer plate 39 are coupled to form the donut-shaped second air room 9, and the second inflow hole 35 and the second discharge hole 37 are formed in the second air room outer plate 39 to allow air to flow into and be discharged from the second air room 9.

In another embodiment, a motor housing 49 is installed and includes a first inflow port 41, a second inflow port 43, a first discharge port 45, and a second discharge duct 47 that are respectively connected to the first inflow branch duct 19, the second inflow branch duct 21, and the discharge ducts 11. In particular, the motor housing 49 is provided outside the stator core 3, the first air room inner plate 25, the first air room outer plate 31, the second air room inner plate 33, and the second air room outer plate 39.

In other words, the first air room 7 and the second air room 9 are configured in the motor housing 49, and the air passing through the first air room 7 is supplied from the first inflow branch duct 19 to the first air room 7 through the first inflow port 41 and the first inflow hole 27 and discharged to the outside through the first discharge hole 29, the first discharge port 45, and the discharge duct 11.

In addition, the air passing through the second air room 9 is supplied from the second inflow branch duct 21 to the second air room 9 through the second inflow port 43 and the second inflow hole 35 and discharged to the outside through the second discharge hole 37, the second discharge port 47, and the discharge duct 11.

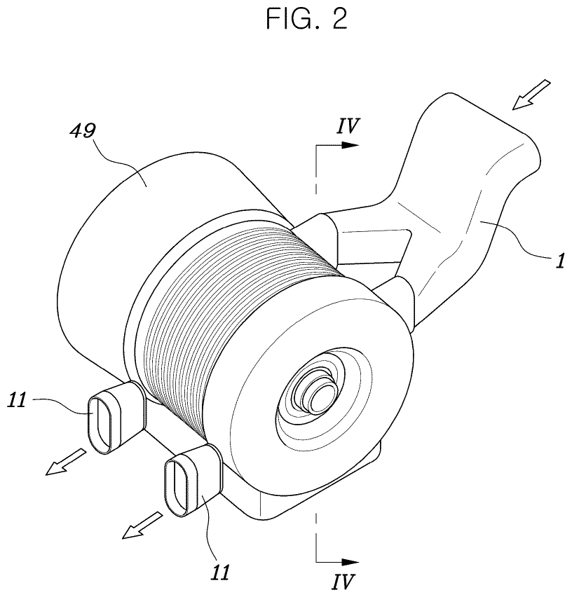

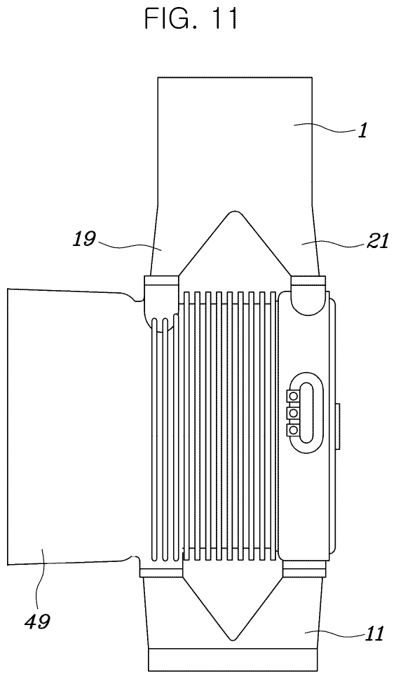

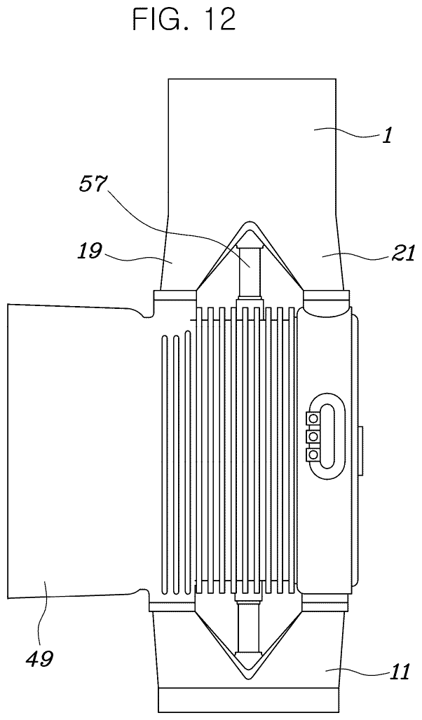

Here, the discharge duct 11 is described without distinguishing the first air room 7 from the second air room 9, and thus may be configured to be connected to each of the first air room 7 and the second air room 9 in a state of being separated individually as shown in FIG. 2 or configured in an integrated shape as shown in FIG. 11 or 12.

The motor housing 49 is provided with a partition wall 53 that divides the motor housing 49 into: i) the first space where the stator core 3, the first air room inner plate 25, the first air room outer plate 31, the second air room inner plate 33, and the second air room outer plate 39 are accommodated, and ii) the second space where a rotational shaft 51 transmits power to other components.

Therefore, a space where oil for lubrication and cooling may flow can be formed on one side, partitioned by the partition wall 53, while another space where oil cannot flow, allowing only cooling by air, may be formed on the other side.

For example, in the second space, the rotational shaft 51 of the motor transmits power to other components and oil that lubricates and cools engaged portions of gears, etc. may flow. In the first space where the first air room 7 and the second air room 9 are provided, only the airflow is possible, without the flow of the oil, and thus lubrication and cooling required to drive the motor can both be effectively performed.

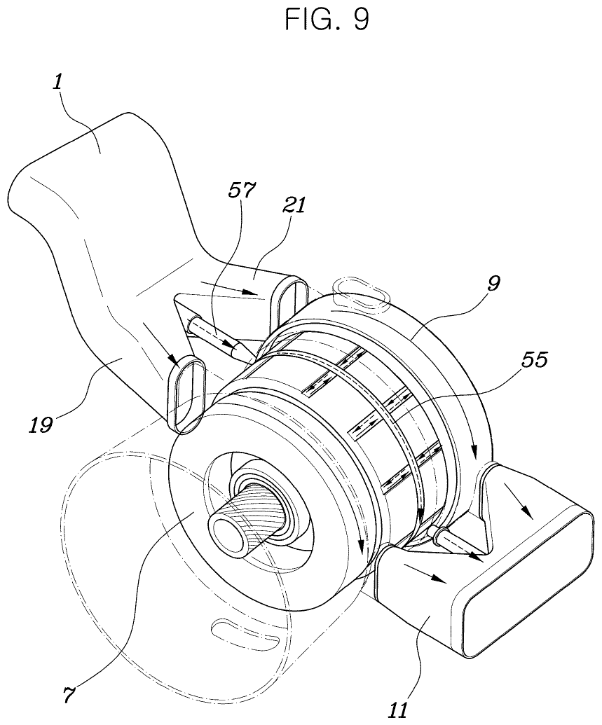

As shown in FIG. 9, between the first air room 7 and the second air room 9, an additional air room 55 may be formed to surround the stator core 3 so that air may flow therein. An additional inflow branch duct 57 branched to supply air from the inflow duct body 17 to the additional air room 55 may be provided.

Therefore, the additional air room 55 may be provided at a location in the stator core 3, which is most heated, or at which cooling is difficult, thereby more effectively cooling the stator core 3.

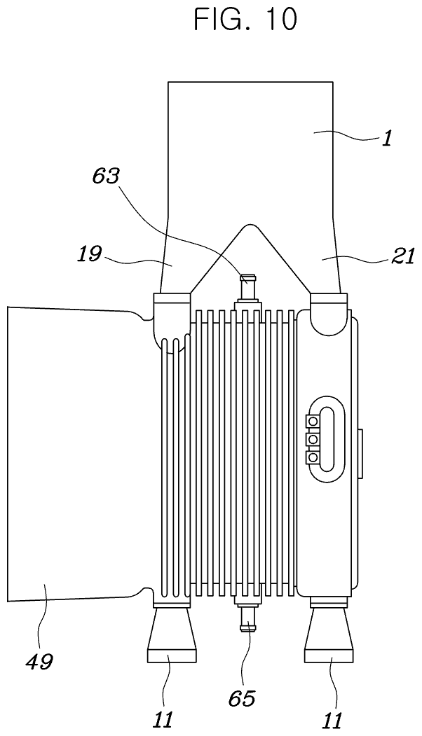

FIG. 10 illustrates an example in which air is supplied to and discharged from the additional air room 55 by an inflow pipe 63 and a discharge pipe 65 that are configured separately from the inflow duct 1 and the discharge duct 11, and a separate air supply source for cooling the motor may be connected to the inflow pipe 63.

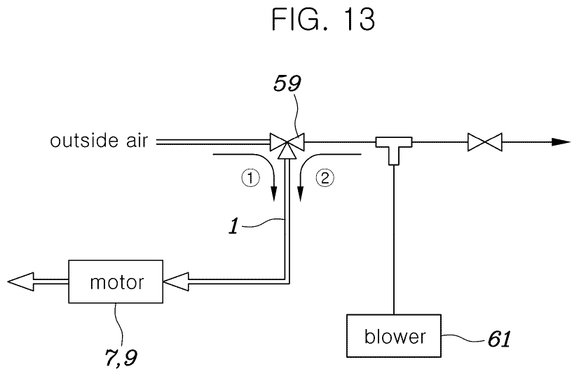

As shown in FIG. 13, the inflow duct 1 may be provided with an air selection valve 59 for selectively supplying cooling air blown from a blower 61 of a vehicle air conditioner to the motor.

Therefore, only traveling wind may flow into the first air room 7 and the second air room 9 or cooling air blown from the blower 61 may be supplied. When only the blower 61 is driven without operating the vehicle air conditioner, the air blown by the blower 61 rather than the cooling air may be forcibly supplied to the first air room 7 and the second air room 9.

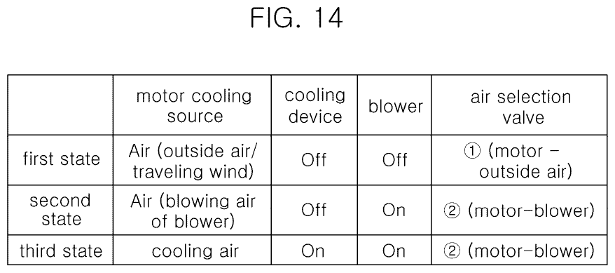

Various cooling states of the motor as shown in FIG. 14 may be implemented according to various air supply methods as described above.

For example, a first state is a state in which both the vehicle air conditioner and the blower 61 are turned off. In the first state, only the outside air or traveling wind of the vehicle is supplied to perform cooling, and the air selection valve 59 allows the motor to communicate with the outside air fluidly.

A second state is a state in which the vehicle air conditioner is turned off and the blower 61 is turned on, In the second state, when the air selection valve 59 fluidly connects the motor to the blower 61, the air blown from the blower 61 is forcibly supplied to the first air room 7 and the second air room 9 of the motor to enable forced cooling.

A third state is a state in which both the vehicle air conditioner and the blower 61 are turned on, and when the air selection valve 59 fluidly connects the motor to the blower 61, the air blown from the blower 61 may be cooled while passing through an evaporator of the air conditioner and then supplied to the motor to very strongly cool the motor.

The above cooling states may be configured so that a controller may select an appropriate state based on a temperature of the motor, a traveling situation of the vehicle, etc.

For example, in a high-speed and low-load situation, the first state may be selected. In a low-speed and high-load situation, a high-temperature stop situation, or the like, the third state may be selected.

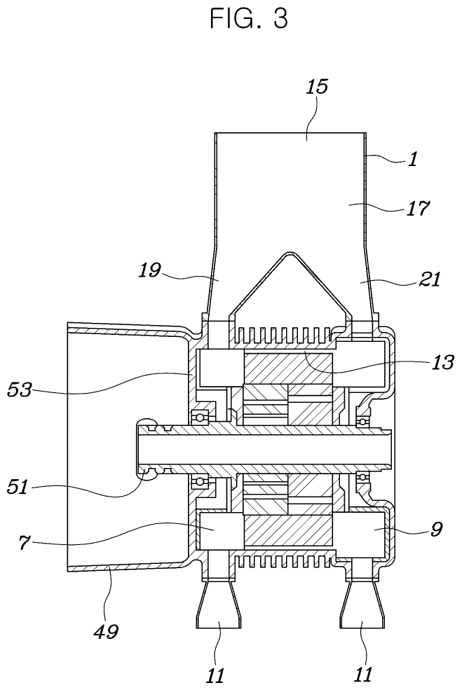

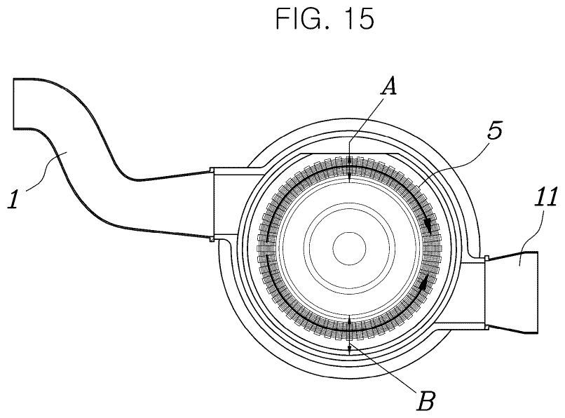

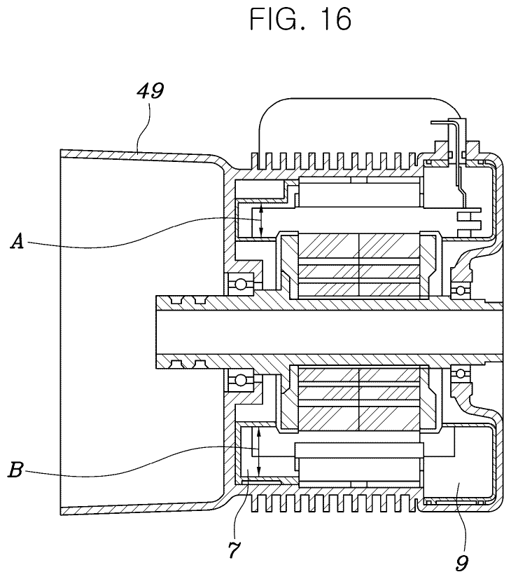

FIGS. 15 and 16 show modified examples of FIGS. 1 and 3, respectively and show that a cross-sectional area of a flow path of the first air room 7 may be configured locally, differently.

For example, referring to FIGS. 15 and 16, a radial flow path width of the first air room 7 is basically set to “B”, and a portion whose flow path width is set to “A” is provided at a portion of an upper side thereof so that the cross-sectional area of the flow path may be locally reduced.

Of course, an example in which the cross-sectional area of the flow path is configured locally, differently as described above may be applied to a case of the second air room 9 in the same manner, and in this way, the example in which the cross-sectional area of the flow path is configured locally, differently may be performed to secure better dispersibility of the flow rate of the flowing air.

The motor for a vehicle according to the present disclosure, which constitutes the motor cooling structure for a vehicle as described above, includes the stator core 3, and the first air room 7 and the second air room 9 that are formed to selectively receive the traveling wind of the vehicle or the air blown from the blower 61 of the vehicle air conditioner to flow the air around the coils 5 on both sides of the stator core 3.

The first air room 7 and the second air room 9 are formed in donut shapes of different sizes, and the connection passage 13 connecting the first air room 7 to the second air room 9 is formed in the stator core 3.

In addition, the motor for a vehicle according to the present disclosure may further include the additional air room 55 formed to surround the stator core 3 so that air may flow therein between the first air room 7 and the second air room 9 to selectively receive the traveling wind of the vehicle or the air blown from the blower 61 of the vehicle air conditioner.

The first air room 7 may include the first air room inner plate 25 having the plurality of coil insertion holes 23 through which portions of the coils 5 may pass and installed at one side of the stator core 3, and the first air room outer plate 31 coupled to the first air room inner plate 25 and having the first inflow hole 27 into which air flows and the first discharge hole 29 through which the air is discharged formed therein.

The second air room 9 may include the second air room inner plate 33 having the plurality of coil insertion holes 23 through which portions of the coils 5 may pass and installed at one side of the stator core 3, and the second air room outer plate 39 coupled to the second air room inner plate 33 and having the second inflow hole 35 into which air flows and the second discharge hole 37 through which the air is discharged formed therein.

The motor housing 49 having the first inflow port 41 and the second inflow port 43 into which air flows, and the first discharge port 45 and the second discharge duct 47 through which the air is discharged formed therein is provided outside the stator core 3, the first air room inner plate 25, the first air room outer plate 31, the second air room inner plate 33, and the second air room outer plate 39.

The motor housing 49 is provided with a partition wall 53 for dividing the motor housing 49 into i) a space in which the stator core 3, the first air room inner plate 25, the first air room outer plate 31, the second air room inner plate 33, and the second air room outer plate 39 are accommodated, and ii) a space in which a rotational shaft 51 transmits power to other components.

Although the specific embodiments of the present disclosure have been illustrated and described, it should be apparent to those having ordinary skill in the art that the present disclosure may be variously improved and changed without departing from the technical spirit of the present disclosure.

What is claimed is:

1. A motor cooling structure for a vehicle, the motor cooling structure comprising:
an inflow duct configured to guide traveling wind of the vehicle to a motor;
a first air room and a second air room formed to direct air supplied from the inflow duct to flow around coils on both sides of a stator core, respectively; and
a discharge duct configured to discharge air having passed through the first air room and the second air room.

2. The motor cooling structure of claim 1, wherein the first air room and the second air room are formed in donut shapes of different sizes, and
a connection passage connecting the first air room to the second air room is formed in the stator core.

3. The motor cooling structure of claim 2, wherein the inflow duct and the discharge duct are connected to opposite sides with respect to donut-shaped centers of the first air room and the second air room.

4. The motor cooling structure of claim 2, wherein the inflow duct includes:
an inflow duct body having one air inflow;
a first inflow branch duct branched from the inflow duct to be connected to the first air room; and
a second inflow branch duct branched from the inflow duct body to be connected to the second air room.

5. The motor cooling structure of claim 4, further comprising: an additional air room formed to surround the stator core so that air flows therein between the first air room and the second air room; and
an additional inflow branch duct branched to supply air from the inflow duct body to the additional air room.

6. The motor cooling structure of claim 4, wherein the first air room includes:
a first air room inner plate having a plurality of coil insertion holes through which portions of the coils pass and installed at one side of the stator core; and
a first air room outer plate coupled to the first air room inner plate and having a first inflow hole communicating with the first inflow branch duct and a first discharge hole communicating with the discharge duct formed therein, and
wherein the second air room includes:
a second air room inner plate having a plurality of coil insertion holes through which portions of the coils pass and installed at one side of the stator core; and
a second air room outer plate coupled to the second air room inner plate and having a second inflow hole communicating with the second inflow branch duct and a second discharge hole communicating with the discharge duct formed therein.

7. The motor cooling structure of claim 6, further comprising a motor housing including: a first inflow port, a second inflow port, a first discharge port, and a second discharge duct that are respectively connected to the first inflow branch duct, the second inflow branch duct, and the discharge ducts, and
wherein the motor housing is provided outside the stator core, the first air room inner plate, the first air room outer, the second air room inner plate, and the second air room outer plate.

8. The motor cooling structure of claim 7, wherein the motor housing is provided with a partition wall configured to divide the motor housing into a first space where the stator core, the first air room inner plate, the first air room outer, the second air room inner plate, and the second air room outer plate are accommodated, and a second space where a rotational shaft transmits power to other components.

9. The motor cooling structure of claim 1, wherein the inflow duct is provided with an air selection valve configured to selectively supply cooling air blown from a blower of a vehicle air conditioner to the motor.

10. A motor for a vehicle, the motor comprising:
a stator core; and
a first air room and a second air room formed to selectively receive traveling wind of the vehicle or air blown from a blower of a vehicle air conditioner to flow the air around coils on both sides of the stator core, respectively.

11. The motor of claim 10, wherein the first air room and the second air room are formed in donut shapes of different sizes, and
a connection passage connecting the first air room to the second air room is formed in the stator core.

12. The motor of claim 11, further comprising an additional air room formed to surround the stator core so that air flows therein between the first air room and the second air room to selectively receive the traveling wind of the vehicle or the air blown from the blower of the vehicle air conditioner.

13. The motor of claim 11, wherein the first air room includes:
a first air room inner plate having a plurality of coil insertion holes through which portions of the coils pass and installed at one side of the stator core; and
a first air room outer plate coupled to the first air room inner plate and having a first inflow hole into which air flows and a first discharge hole through which the air is discharged, and
wherein the second air room includes:
a second air room inner plate having a plurality of coil insertion holes through which portions of the coils pass and installed at one side of the stator core; and
a second air room outer plate coupled to the second air room inner plate and having a second inflow hole into which air flows and a second discharge hole through which the air is discharged.

14. The motor of claim 13, further comprising: a motor housing including a first inflow port and a second inflow port into which air flows, and a first discharge port and a second discharge duct through which the air is discharged is provided outside the stator core, the first air room inner plate, the first air room outer, the second air room inner plate, and the second air room outer plate.

15. The motor of claim 14, wherein the motor housing is provided with a partition wall configured to partition the motor housing into a first space in which the stator core, the first air room inner plate, the first air room outer, the second air room inner plate, and the second air room outer plate are accommodated, and a second space in which a rotational shaft transmits power to other components.
